(19) United States
(12) Patent Application Publication
(10) Pub. No.: US 2026/0166538 A1
(43) Pub. Date: Jun. 18, 2026

(54) FERROCENE-DOPED MOF-DERIVED METAL CARBIDE ELECTROCATALYST, AND PREPARATION METHOD AND APPLICATION THEREOF

(71) Applicant: ANHUI UNIVERSITY OF SCIENCE & TECHNOLOGY, Huainan City (CN)

(72) Inventors: Jinsong HU, Huainan City (CN); Youcheng FENG, Huainan City (CN); Qianxi SHI, Huainan City (CN); Cuiping WANG, Huainan City (CN)

(73) Assignee: ANHUI UNIVERSITY OF SCIENCE & TECHNOLOGY, Huainan City, AH (CN)

(21) Appl. No.: 18/854,988

(22) PCT Filed: Mar. 25, 2024
(86) PCT No.: PCT/CN2024/083442

§ 371 Date: Oct. 8, 2024

(30) Foreign Application Priority Data
Apr. 27, 2023 (CN) 202310484680.8

(51) Int. Cl. B01J 31/18; B01J 23/745; H01M 4/90; H01M 4/92

(52) U.S. Cl. CPC B01J 31/1805; B01J 23/745; H01M 4/90; H01M 4/926; B01J 2531/64

(57) ABSTRACT

A ferrocene-doped MOF-derived metal carbide electrocatalyst, and a preparation method and application thereof are disclosed. The preparation method includes: dissolving ZIF-8 in absolute methanol to prepare a solution A, and dissolving ferrocene monocarboxylic acid in DMF to prepare a solution B; uniformly mixing the solution A with the solution B to prepare a reaction solution, and performing a hydrothermal reaction on the reaction solution; and centrifuging, washing, oven-drying, and calcining and carbonizing a product obtained after the reaction to prepare the ferrocene-doped MOF-derived metal carbide electrocatalyst. The catalyst of the present disclosure has the advantages of porousness, multiple active sites, and the like, which further improve catalytic properties of the electrocatalyst. The electrocatalyst can be applied to a primary zinc-air battery as an oxygen reduction catalyst, and has excellent electrochemical properties under alkaline conditions (0.1 M KOH).

### TECHNICAL FIELD

The present disclosure relates to the technical field of catalysts, and specifically, to a ferrocene-doped MOF-derived metal carbide electrocatalyst, and a preparation method and application thereof.

### BACKGROUND ART

With the development of science and technology, energy consumption is also increasing. In face of this problem, people make constant efforts in innovating technology, developing new energy, and finding more sustainable and renewable clean energy. The electrochemical technology is attracting more and more attention by virtue of its ability to serve as a medium for energy conversion and storage. A current research hotspot is to design and develop a low-cost sustainable green electrochemical energy storage device.

Metal-organic frameworks (MOFs) and MOF-derived materials have attracted widespread attention as alternatives to noble metal-based electrocatalysts by virtue of their interesting structural properties, especially efficient and stable oxygen reduction reaction (ORR). Zinc-air batteries (ZABs) mainly involve oxygen reduction reaction, and the practical application of the zinc-air batteries is largely limited by inefficient kinetics of ORR. In order to improve the speed and efficiency of the reaction, it is usually necessary to use high-performance electrocatalytic materials to improve the half-wave potential (E_{1/2}) for ORR. However, most of the current efficient catalysts are noble metals. Therefore, in order to overcome the deficiencies of the zinc-air batteries, exploration of efficient stable low-cost catalysts is the future development trend.

The Chinese Application No. CN110148764A discloses a bifunctional catalyst for catalyzing ORR and OER, and a preparation method and application thereof. An atomically dispersed Fe—Co bimetallic site (FeCo—NC) is obtained from a Fe, Co-codoped zeolitic imidazolate framework (ZIF-8s). However, the atomically dispersed FeCo—NC catalyst has a poor effect on ORR (E_{1/2}=0.877 V) in an alkaline medium.

### SUMMARY OF THE INVENTION

A technical problem to be solved by the present disclosure is to provide a novel ferrocene-containing electrocatalyst with good catalytic properties and a preparation method thereof. The prepared catalyst can effectively improve catalytic properties of oxidation reduction reaction.

The present disclosure adopts the following technical means to solve the foregoing technical problem.

A preparation method of a ferrocene-doped MOF-derived metal carbide electrocatalyst includes the following steps:
S1: dissolving ZIF-8 in absolute methanol to prepare a solution A, and dissolving ferrocene monocarboxylic acid in DMF to prepare a solution B;
S2: uniformly mixing the solution A with the solution B to prepare a reaction solution, and performing a hydrothermal reaction on the reaction solution; and
S3: centrifuging, washing, oven-drying, and calcining and carbonizing a product obtained after the reaction in S2 to prepare the ferrocene-doped MOF-derived metal carbide electrocatalyst.

Preferably, in S1, a mass-to-volume ratio of ZIF-8 to absolute methanol is 20 mg: 2 mL.

Preferably, in S1, a mass-to-volume ratio of ferrocene monocarboxylic acid to DMF is (2-10) mg: 2 mL.

Preferably, in S2, in the reaction solution, a mass ratio of ZIF-8 to ferrocene monocarboxylic acid is 20: (2-10).

Preferably, in S2, the hydrothermal reaction is performed at 100° C. for 12-24 h.

Preferably, in S3, the centrifugation is performed at 6,000-10,000 r/min for 3-5 min, and the oven-drying is performed at 45-55° C. for 4-12 h.

Preferably, in S3, the calcination includes: placing an oven-dried material in a porcelain combustion boat, placing the porcelain combustion boat in a tube furnace, and performing primary heating and calcination under the protection of inert gas; and performing acid leaching on the material in a 0.3-0.6 M H₂SO₄ solution for 20-30 h, placing the material in the porcelain combustion boat, placing the porcelain combustion boat in the tube furnace, and performing secondary heating and calcination under the same conditions as the primary heating and calcination.

Preferably, the primary heating and calcination and the secondary heating and calcination are performed at 900-950° C. and a heating rate of 3-5° C./min for 1.5-2.5 h.

The present disclosure further proposes a ferrocene-doped MOF-derived metal carbide electrocatalyst, which is prepared by the preparation method of the ferrocene-doped MOF-derived metal carbide electrocatalyst.

The present disclosure further proposes application of the ferrocene-doped MOF-derived metal carbide electrocatalyst serving as an oxygen reduction catalyst in a zinc-air battery.

The present disclosure has the following advantages:
(1) In the present disclosure, ZIF-8 serves as a precursor, an iron salt serves as a metal salt, the precursor ZIF-8 is wrapped in ferrocene monocarboxylic acid, and pyrolysis is performed to prepare a dodecahedral porous composite material, which has good overall morphology and excellent thermal stability.
(2) The composite material of the present disclosure can effectively generate a porous structure by instantly releasing heat during pyrolysis, and maintain good overall morphology before and after pyrolysis. The composite material can be applied to a primary zinc-air battery as an oxygen reduction catalyst, and has excellent electrochemical properties under alkaline conditions (0.1 M KOH).
(3) The preparation process of the present disclosure is simple, is easy to reproduce, has high yield, and thus is convenient for industrial production.

### BRIEF DESCRIPTION OF DRAWINGS

FIG. 1 shows a process flowchart of Example 1 of the present disclosure;

FIG. 2 shows SEM images of a precursor ZIF-8, ZnFc-MOF-M, and Fe3C—FeN/C—M of Example 2 of the present disclosure, and in the figure, (a) is the SEM image of the precursor ZIF-8, (b) is the SEM image of ZnFc-MOF-M; and (c) is the SEM image of FE₃C—FEN/C—M;

FIG. 3 shows TEM images (a) and (b), a crystal lattice analysis diagram (c), and a crystal lattice pattern (d) of Fe₃C—FeN/C—M of Example 2 of the present disclosure;

FIG. 4 shows a polarization curve (a) for oxygen reduction reaction of a material Fe₃C—FeN/C—M of Example 2 of the present disclosure in an O₂-saturated 0.1 M KOH aqueous solution at 1,600 rpm, a corresponding Tafel slope (b), a methanol tolerance curve (c), a stability test (d) of oxygen reduction reaction, and LSV (e) before and after the stability test of oxygen reduction reaction;

FIG. 5 shows a polarization curve and a power density curve (a), a specific capacity curve (b), and a discharge curve (c) of a zinc-air battery using a Fe₃C—FeN/C—M catalyst of Example 2 at a current density of 10 mA/cm², and a discharge curve (d) at different current densities;

FIG. 6 shows LSV curves of catalysts of Example 1 to Example 3, as well as Comparison Example 1 and Comparison Example 2 of the present disclosure; and

FIG. 7 is an SEM image of a material of Comparison Example 4 of the present disclosure.

### DETAILED DESCRIPTION OF THE INVENTION

In order to make the objectives, the technical solutions, and the advantages of the present disclosure clearer, the following clearly and completely describes the technical solutions in embodiments of the present disclosure with reference to the embodiments of the present disclosure. Apparently, the described embodiments are only some but not all of the embodiments of the present disclosure. All other embodiments obtained by those of ordinary skill in the art based on the embodiments of the present disclosure without involving any creative effort shall fall within the scope of protection of the present disclosure.

Unless otherwise specified, experimental materials, reagents, and the like used in the following embodiments are all commercially available.

In the embodiments, all experiments described without specifying specific technology or conditions may be conducted according to the technology or conditions described in documents in the art or instructions of products.

In the embodiments of the present disclosure, zinc nitrate hexahydrate was purchased from Shanghai Macklin Biochemical Technology Co., Ltd.; potassium hydroxide, absolute methanol, and a Nafion solution were purchased from Sinopharm Chemical Reagent Co., Ltd.; N,N-dimethylformamide (DMF) was purchased from Jiangsu Chinasun Specialty Products Co., Ltd. All the foregoing raw materials were analytically pure.

Among testing devices used in the present disclosure, a scanning electron microscope (SEM, FlexSEM1000) was purchased from Hitachi High-Tech Corporation; a transmission electron microscope (TEM, JEM2100F) was purchased from Japan JEOL Ltd.; and an electrochemical workstation was purchased from Shanghai CH Instruments Co., Ltd.

### Example 1

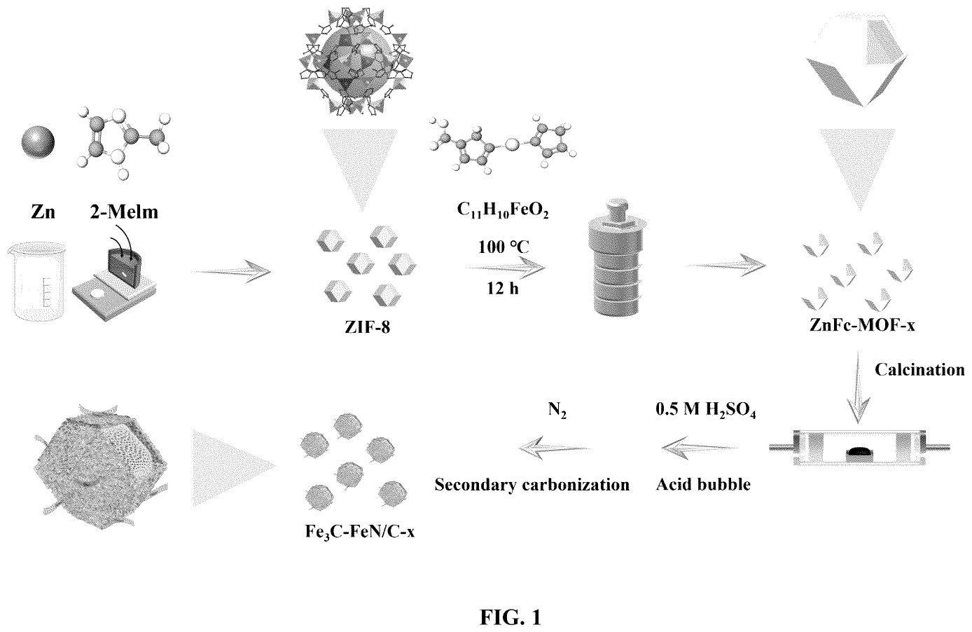

FIG. 1 shows a process flowchart of a preparation method of a ferrocene-doped MOF-derived metal carbide electrocatalyst of the present disclosure. Refer to FIG. 1. The preparation method included the following steps:
S1: 6.16 g of 2-methylimidazole was weighed and dissolved in 150 mL of methanol to prepare a solution A, 5.95 g of Zn(NO₃)₂·6H₂O was dissolved in 150 mL of methanol to prepare a solution B, the completely dissolved solution A was added to the solution B, the mixed solution was stirred for 30 min, placed for 24 h, and centrifuged, an obtained precipitate was washed three times with absolute methanol, and dried in an oven at 50° C. to prepare white powder, which was a precursor ZIF-8; 20 mg of precursor ZIF-8 was weighed, placed in a beaker, and dissolved in 2 mL of absolute methanol solution to form a precursor solution; and 2 mg of ferrocene monocarboxylic acid was weighed, placed in a beaker, and dissolved in 2 mL of DMF solution to prepare a uniform clear solution.
S2: the clear solution obtained in S1 was added to the precursor solution obtained in S1 at room temperature, and the mixed solution was ultrasonically stirred for 30 min, so that the materials were uniformly mixed to prepare a reaction solution.
S3: the reaction solution obtained in S2 was placed in a high pressure reactor and subjected to hydrothermal reaction at 100° C. for 12 h.
S4: a suspension obtained after the hydrothermal reaction was centrifuged, washed, and oven-dried, the centrifugation was performed at 8,000 r/min for 3 min, and the oven-drying was performed at 50° C. for 12 h; 20 mg of oven-dried material ZnFc-MOF-L was placed in a porcelain combustion boat, the porcelain combustion boat was placed in a tube furnace, and the material was heated to 920° C. at a heating rate of 5° C./min and subjected to heating reaction under the protection of flowing nitrogen for 2 h. The material was subjected to acid leaching in a 0.5 M H₂SO₄ solution for 24 h and placed in the porcelain combustion boat, the porcelain combustion boat was placed in the tube furnace, the material was heated to 920° C. at a heating rate of 5° C./min and subjected to heating reaction under the protection of flowing nitrogen for 2 h to prepare the ferrocene-doped MOF-derived metal carbide electrocatalyst, which was a dodecahedral composite material Fe₃C—FeN/C—L.

### Example 2

A preparation method of a ferrocene-doped MOF-derived metal carbide electrocatalyst of the present disclosure included the following steps:
S1: 20 mg of precursor ZIF-8 of Example 1 was weighed, placed in a beaker, and dissolved in 2 mL of absolute methanol solution to form a precursor solution; and 5 mg of ferrocene monocarboxylic acid was weighed, placed in a beaker, and dissolved in 2 mL of DMF solution to prepare a uniform clear solution.
S2: the clear solution obtained in S1 was added to the precursor solution obtained in S1 at room temperature, and the mixed solution was ultrasonically stirred for 30 min, so that the materials were uniformly mixed to prepare a reaction solution.
S3: the reaction solution obtained in S2 was placed in a high pressure reactor and subjected to hydrothermal reaction at 100° C. for 12 h.
S4: a suspension obtained after the hydrothermal reaction was centrifuged, washed, and oven-dried, the centrifugation was performed at 8,000 r/min for 3 min, and the oven-drying was performed at 50° C. for 12 h; 20 mg of oven-dried material ZnFc-MOF-M was placed in a porcelain combustion boat, the porcelain combustion boat was placed in a tube furnace, and the material was heated to 920° C. at a heating rate of 5° C./min and subjected to heating reaction under the protection of flowing nitrogen for 2 h. The material was subjected to acid leaching in a 0.5 M H₂SO₄ solution for 24 h and placed in the porcelain combustion boat, the porcelain combustion boat was placed in the tube furnace, and the material was heated to 920° C. at a heating rate of 5° C./min and subjected to heating reaction under the protection of flowing nitrogen for 2 h to prepare the ferrocene-doped MOF-derived metal carbide electrocatalyst, which was a dodecahedral composite material Fe₃C—FeN/C—M.

### Example 3

A preparation method of a ferrocene-doped MOF-derived metal carbide electrocatalyst of the present disclosure included the following steps:
S1: 20 mg of precursor ZIF-8 of Example 1 was weighed, placed in a beaker, and dissolved in 2 mL of absolute methanol solution to form a precursor solution; and 10 mg of ferrocene monocarboxylic acid was weighed, placed in a beaker, and dissolved in 2 mL of DMF solution to prepare a uniform clear solution.
S2: the clear solution obtained in S1 was added to the precursor solution obtained in S1 at room temperature, and the mixed solution was ultrasonically stirred for 30 min, so that the materials were uniformly mixed to prepare a reaction solution.
S3: the reaction solution obtained in S2 was placed in a high pressure reactor and subjected to hydrothermal reaction at 100° C. for 12 h.
S4: a suspension obtained after the hydrothermal reaction was centrifuged, washed, and oven-dried, the centrifugation was performed at 8,000 r/min for 3 min, and the oven-drying was performed at 50° C. for 12 h; and 20 mg of oven-dried material ZnFc-MOF-H was placed in a porcelain combustion boat, the porcelain combustion boat was placed in a tube furnace, and the material was heated to 920° C. at a heating rate of 5° C./min and subjected to heating reaction under the protection of flowing nitrogen for 2 h. The material was subjected to acid leaching in a 0.5 M H₂SO₄ solution for 24 h and placed in the porcelain combustion boat, the porcelain combustion boat was placed in the tube furnace, and the material was heated to 920° C. at a heating rate of 5° C./min and subjected to heating reaction under the protection of flowing nitrogen for 2 h to prepare the ferrocene-doped MOF-derived metal carbide electrocatalyst, which was a dodecahedral composite material Fe₃C—FeN/C—H.

### Example 4

A preparation method of a ferrocene-doped MOF-derived metal carbide electrocatalyst of the present disclosure included the following steps:
S1: 20 mg of precursor ZIF-8 of Example 1 was weighed, placed in a beaker, and dissolved in 2 mL of absolute methanol solution to form a precursor solution; and 5 mg of ferrocene monocarboxylic acid was weighed, placed in a beaker, and dissolved in 2 mL of DMF solution to prepare a uniform clear solution.
S2: the clear solution obtained in S1 was added to the precursor solution obtained in S1 at room temperature, and the mixed solution was ultrasonically stirred for 30 min, so that the materials were uniformly mixed to prepare a reaction solution.
S3: the reaction solution obtained in S2 was placed in a high pressure reactor and subjected to hydrothermal reaction at 100° C. for 24 h.
S4: a suspension obtained after the hydrothermal reaction was centrifuged, washed, and oven-dried, the centrifugation was performed at 10,000 r/min for 5 min, and the oven-drying was performed at 45° C. for 10 h; and 20 mg of oven-dried material was placed in a porcelain combustion boat, the porcelain combustion boat was placed in a tube furnace, and the material was heated to 900° C. at a heating rate of 4° C./min and subjected to heating reaction under the protection of flowing nitrogen for 2.5 h. The material was subjected to acid leaching in a 0.3 M H₂SO₄ solution for 20 h and placed in the porcelain combustion boat, the porcelain combustion boat was placed in the tube furnace, and the material was heated to 900° C. at a heating rate of 4° C./min and subjected to heating reaction under the protection of flowing nitrogen for 2.5 h to prepare the ferrocene-doped MOF-derived metal carbide electrocatalyst, which was a dodecahedral composite material.

### Example 5

A preparation method of a ferrocene-doped MOF-derived metal carbide electrocatalyst of the present disclosure included the following steps:
S1: 20 mg of precursor ZIF-8 of Example 1 was weighed, placed in a beaker, and dissolved in 2 mL of absolute methanol solution to form a precursor solution; and 5 mg of ferrocene monocarboxylic acid was weighed, placed in a beaker, and dissolved in 2 mL of DMF solution to prepare a uniform clear solution.
S2: the clear solution obtained in S1 was added to the precursor solution obtained in S1 at room temperature, and the mixed solution was ultrasonically stirred for 30 min, so that the materials were uniformly mixed to prepare a reaction solution.
S3: the reaction solution obtained in S2 was placed in a high pressure reactor and subjected to hydrothermal reaction at 100° C. for 20 h.
S4: a suspension obtained after the hydrothermal reaction was centrifuged, washed, and oven-dried, the centrifugation was performed at 6,000 r/min for 4 min, and the oven-drying was performed at 55° C. for 4 h; and 20 mg of oven-dried material was placed in a porcelain combustion boat, the porcelain combustion boat was placed in a tube furnace, and the material was heated to 950° C. at a heating rate of 3° C./min and subjected to heating reaction under the protection of flowing nitrogen for 1.5 h. The material was subjected to acid leaching in a 0.6 M H₂SO₄ solution for 30 h and placed in the porcelain combustion boat, the porcelain combustion boat was placed in a tube furnace, and the material was heated to 950° C. at a heating rate of 3° C./min and subjected to heating reaction under the protection of flowing nitrogen for 1.5 h to prepare the ferrocene-doped MOF-derived metal carbide electrocatalyst, which was a dodecahedral composite material.

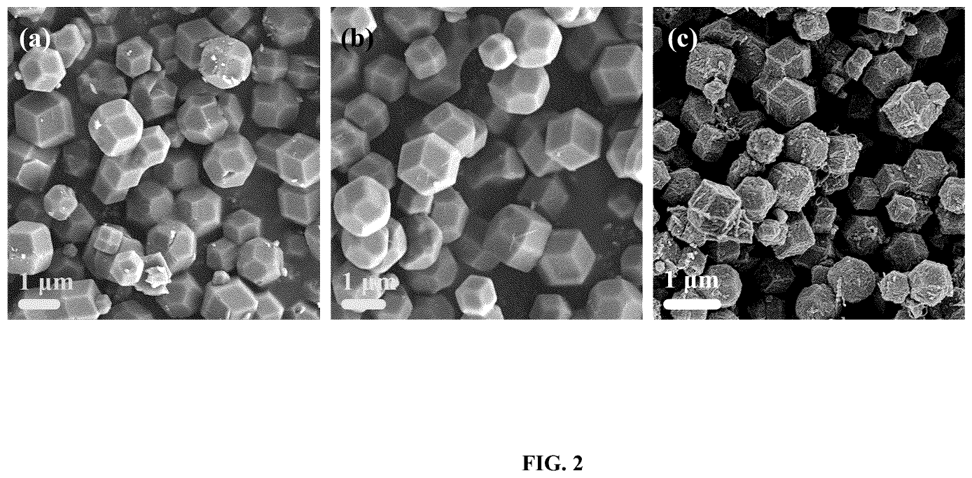

It can be known from FIG. 2 that in a case that the precursor is not added with the iron salt, the sample has dodecahedral morphology and a small size (see FIG. 2a), and in a case that the precursor is added with the iron salt, the MOF sample has similar dodecahedral morphology (see FIG. 2b). In addition, it can be found that after high-temperature calcination, the catalyst maintains intact dodecahedral morphology without damage (see FIG. 2c). The MOF sample that is not damaged after high-temperature calcination shows that the sample has good thermal stability.

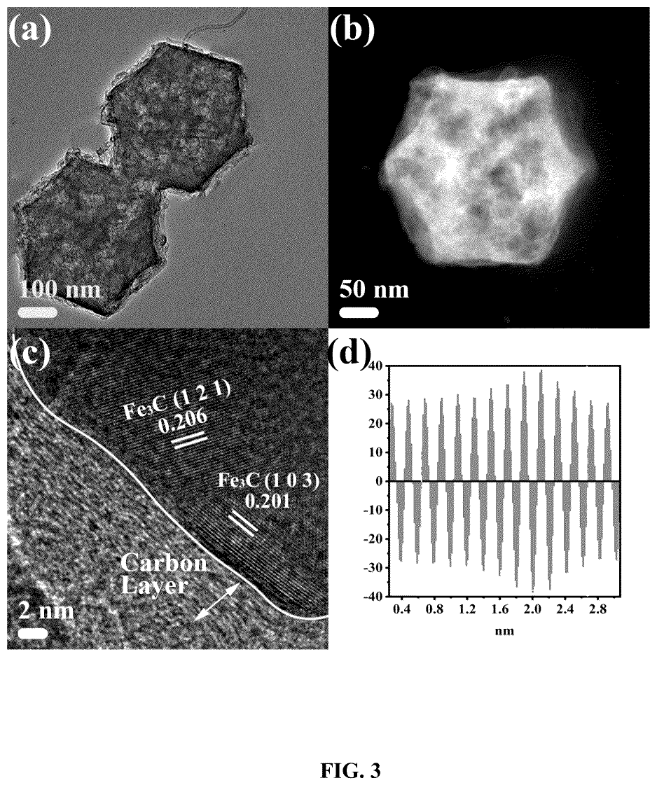

With regard to the composite Fe₃C—FeN/C—M that is derived from ZnFc-MOF-M, the morphology and composition of the product of Example 2 were further examined by TEM. According to transmission electron microscopy (TEM) analysis (see FIG. 3a and FIG. 3b), the morphology of the precursors of all samples are basically kept unchanged, but the particle size is reduced. It is found from an HRTEM image in FIG. 3c that the spacing between lattice fringes is 0.201 nm, and corresponds to a (103) crystal plane, which indicates the existence of a Fe₃C nanocrystal. In addition, the existence of (103) and (121) crystal planes in the selected crystal lattice pattern further proves the existence of Fe₃C (see FIG. 3c and FIG. 3d).

Oxygen reduction properties of the sample were characterized by using a three-electrode system on a CHI760D electrochemical workstation and a rotating disk electrode (RDE). 5 mg of sample obtained in the experiment was weighed and added with 480 μL of ethanol, 480 μL of H₂O, and 40 μL of perfluorosulfonic acid (Nafion) solution, and the mixture was subjected to ultrasonic treatment for 30 min, so that the sample completely dispersed. A suspension of the sample was uniformly dropwise added to the rotating disk electrode in two batches of 5 μL each time, and dried by using an oven lamp. In the three-electrode system, a working electrode is a disk electrode, a counter electrode was a graphite electrode, and a reference electrode was a saturated calomel electrode (SCE). An O₂-saturated 0.1 M KOH solution (pH=13) served as an electrolyte. A potential used in the present study was converted to a corresponding value of a reversible hydrogen electrode (RHE) according to a formula of E_{RHE}=E_{SCE}+0.244+0.0591×pH. E_{SCE} is a potential applied to the reference electrode (SCE). The rotating disk electrode rotated at different rotating speeds from 400 rpm to 2,025 rpm. The long-term stability was tested by chronopotentiometry. A zinc-air battery was prepared from zinc powder and a 6.0 M KOH solution, the catalyst was loaded on a foam nickel substrate, and a polarization curve for ORR was recorded by linear potential scanning at a scanning rate of 10 mV/s. The long-term stability and methanol toxicity resistance were tested by chronoamperometry.

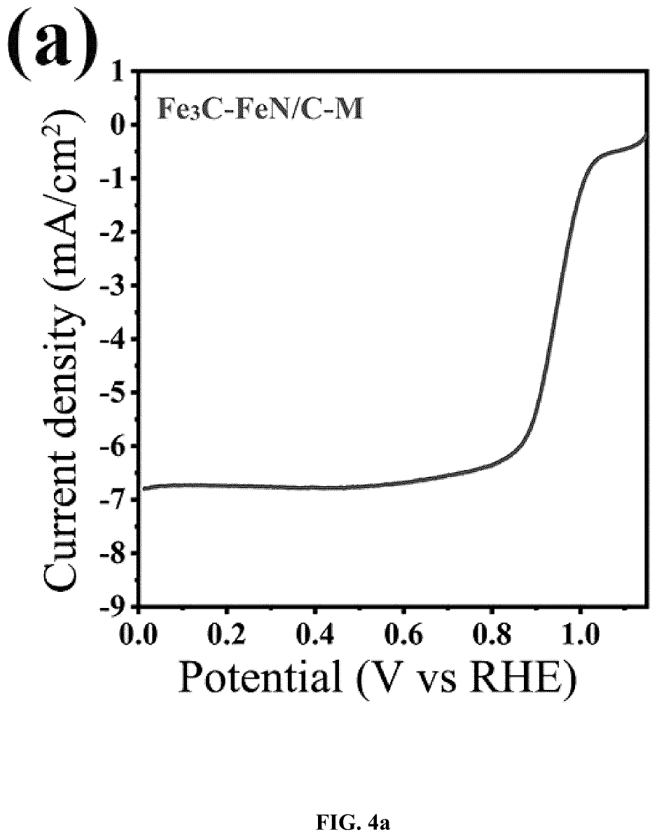

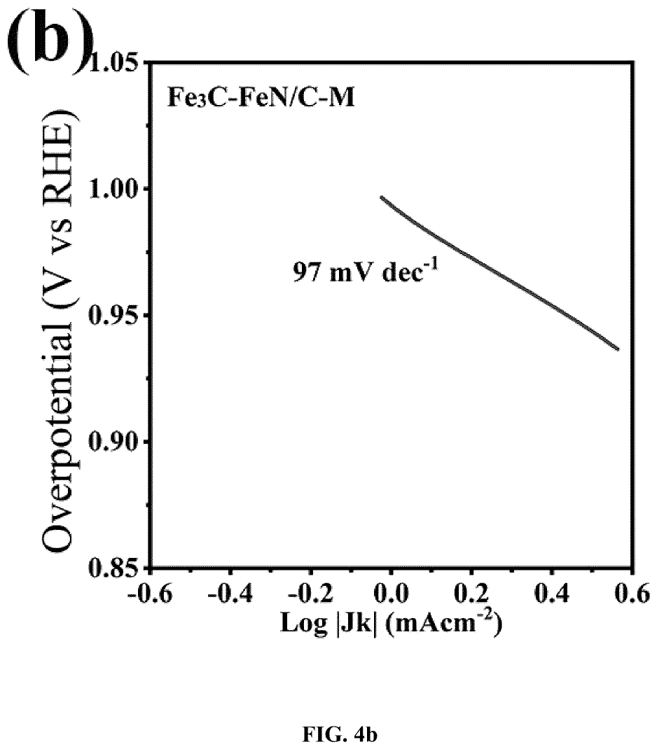

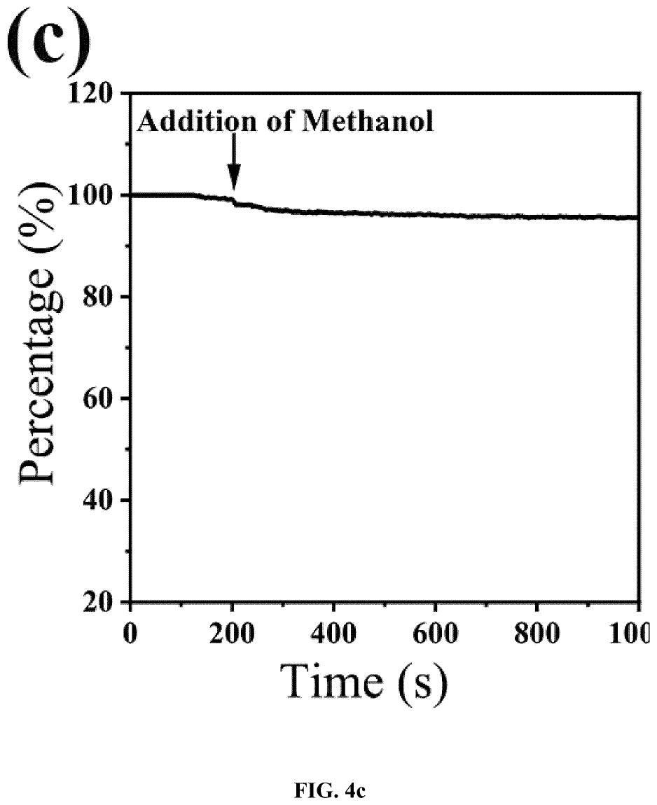

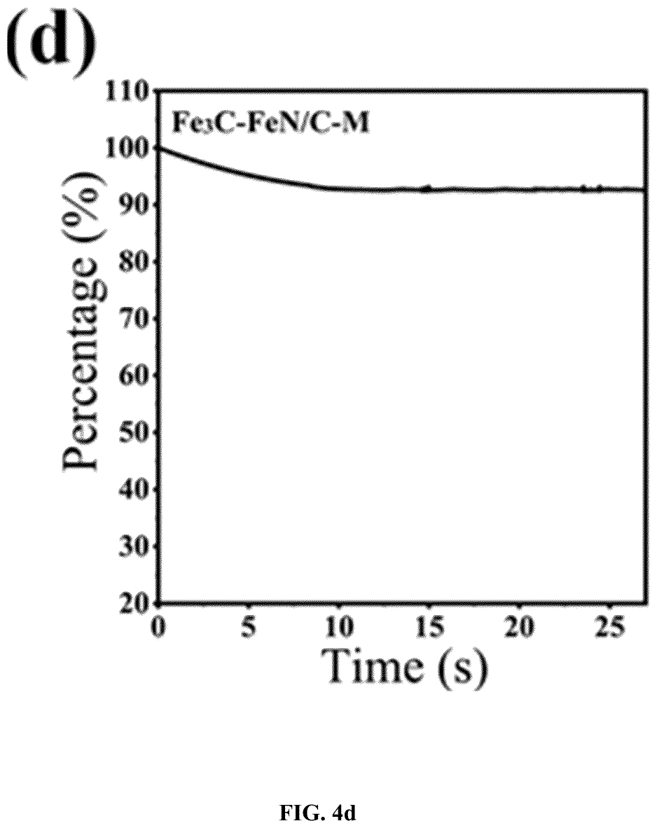

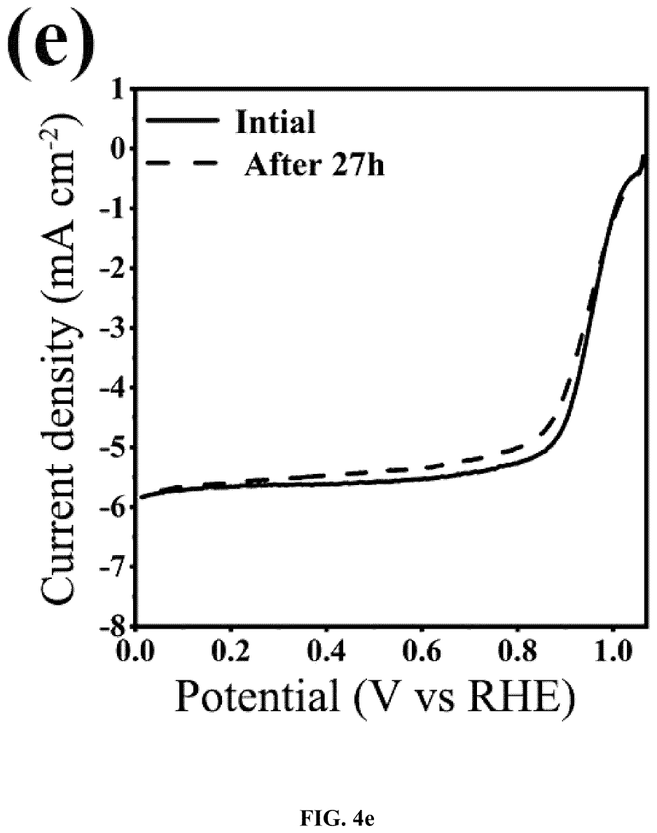

The ORR properties of the product of Example 2 are as follows: as shown in FIG. 4a, the half-wave potential E_{1/2}=0.941 V, and the limited current J_{L}=6.31 mA/cm²; and the Tafel slope is 97 mV/dec (see FIG. 4b). It can be seen from FIG. 4c that after 1 mL of methanol is added at 200 s, the properties of Fe₃C—FeN/C—M have almost no change, which indicates that Fe₃C—FeN/C—M is highly resistant to methanol poisoning. In addition, the stability of the catalyst for ORR was tested at a voltage of 0.8 V. Results are shown in FIG. 4d. After 24 hours of continuous reaction, a current retention rate for ORR is 92.6%, which proves the excellent stability of the catalyst for ORR. The long-term durability is an important criterion for evaluating the properties of a catalyst. As shown in FIG. 4e, it is found by a test at 1,600 rpm that a difference between an LSV curve (shown as After 27 h in the figure) of the catalyst and an initial LSV curve (shown as Initial in the figure) is 12 mV, which verifies that one of the active sites in the catalyst is Fe—Nₓ.

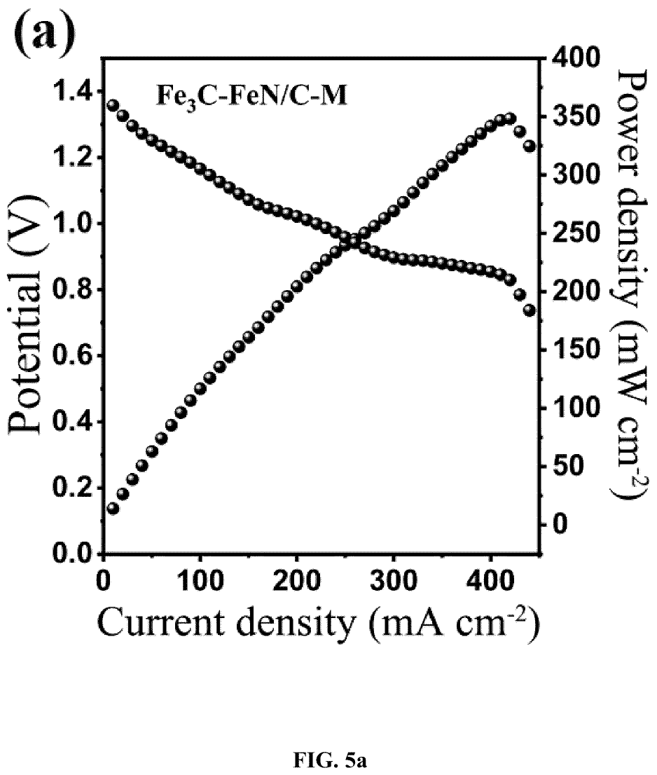

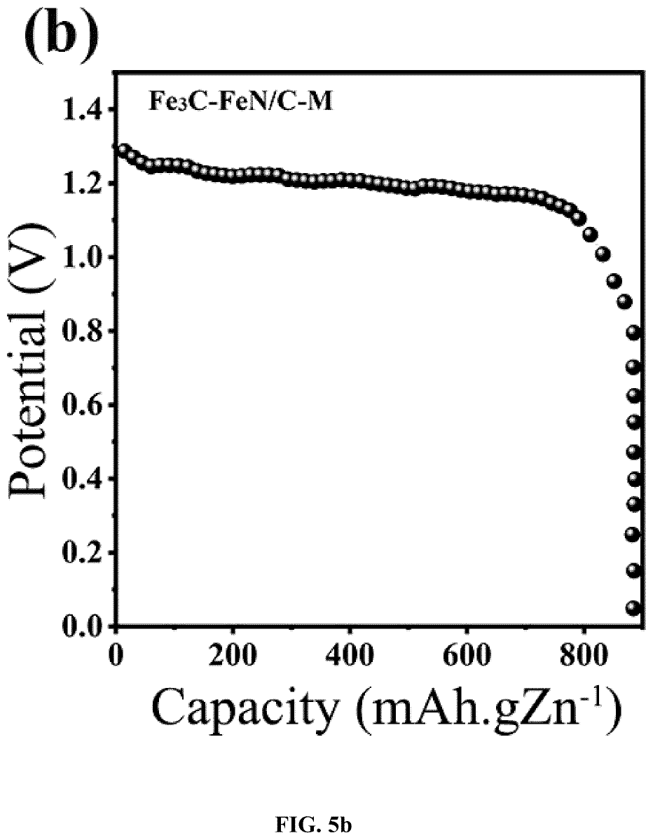

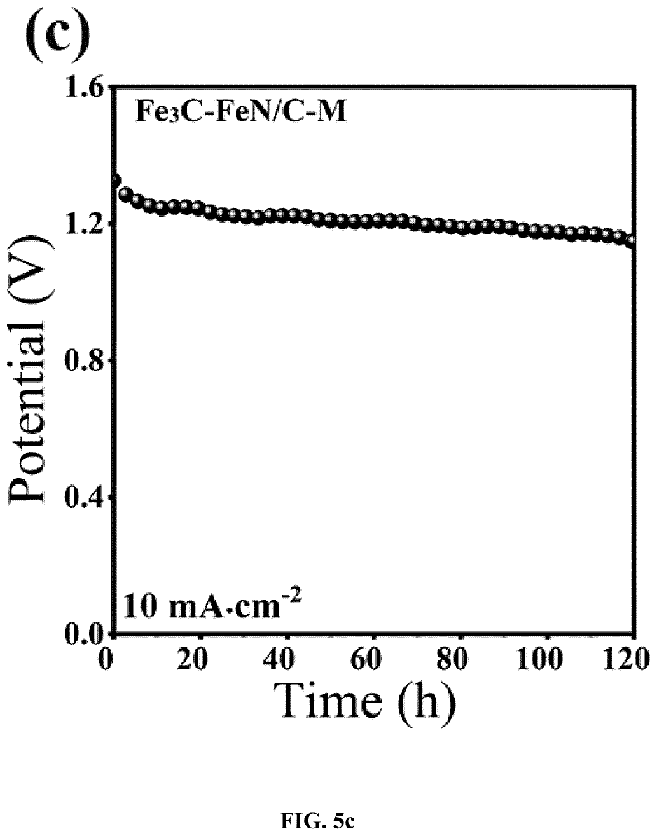

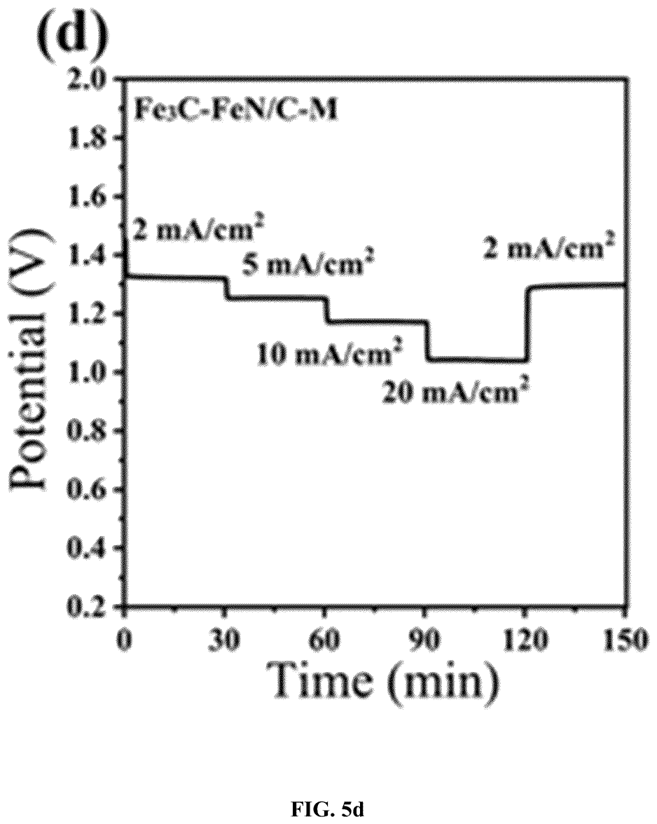

In addition, properties and stability of a primary zinc-air battery (ZAB) using the catalyst of Example 2 were further tested. As shown in FIG. 5a, a peak power density of the catalyst at 420 mA/cm² is 348 mW/cm², which is greater than a peak power density (164 mW/cm² at 300 mA/cm²) of commercially available Pt/C (20 wt %) under the same zinc-air battery configuration. Then, a specific capacity of the assembled primary battery was measured at 10 mA/cm². If it is normalized to the mass consumption of zinc, a specific capacity of Fe₃C—FeN/C—M is 843 mAh/g_{Zn} (see FIG. 5b), which is greater than 652 mAh/g_{Zn} of commercially available Pt/C (20 wt %). At 10 mA/cm², an initial potential of the Fe₃C—FeN/C—M-assembled Zn—air battery is 1.414 V, and after 120 hours of continuous operation, the potential can maintain good stability with a decay of 8.8% (see FIG. 5c), which indicates that Fe₃C—FeN/NC—M has good electrocatalytic stability for ORR in the actual ZAB. In order to study a rate capability of the battery, a discharge test (see FIG. 5d) was conducted at current densities from 2 to 20 mA/cm². Compared with a ZAB based on commercially available Pt/C (20 wt %), the Fe₃C—FeN/C—M-assembled ZAB shows a smaller drop in voltage when the current density returns back to 2.0 mA/cm², which is only 1.0%. This indicates that Fe₃C—FeN/C—M, as an oxygen catalyst for a cathode of the ZAB, has ideal durability and excellent reusability.

### Comparison Example 1

A preparation method of an MOF-derived metal carbide electrocatalyst included the following steps:
S1: 20 mg of precursor ZIF-8 of Example 1 was weighed, placed in a beaker, and dissolved in 2 mL of absolute methanol solution to form a suspension.
S2: the suspension obtained in S1 was centrifuged, washed, and oven-dried, the centrifugation was performed at 8,000 r/min for 3 min, and the oven-drying was performed at 50° C. for 12 h; and 20 mg of oven-dried material was placed in a porcelain combustion boat, the porcelain combustion boat was placed in a tube furnace, and the material was heated to 920° C. at a heating rate of 5° C./min and subjected to heating reaction under the protection of flowing nitrogen for 2 h. The material was subjected to acid leaching in a 0.5 M H₂SO₄ solution for 24 h and placed in the porcelain combustion boat, the porcelain combustion boat was placed in the tube furnace, and the material was heated to 920° C. at a heating rate of 5° C./min and subjected to heating reaction under the protection of flowing nitrogen for 2 h to prepare a dodecahedral composite material N/C.

### Comparison Example 2

A preparation method of a ferrocene-doped MOF-derived metal carbide electrocatalyst included the following steps:
S1: 20 mg of precursor ZIF-8 of Example 1 was weighed and placed in a beaker; 5 mg of ferrocene monocarboxylic acid was weighed and placed in a beaker, and the powder was poured from the two beakers into a mortar in sequence, and ground and mixed to prepare uniformly mixed powder.
S2: 20 mg of mixed material ZnFc-MOF-mix was placed in a porcelain combustion boat, the porcelain combustion boat was placed in a tube furnace, the material was heated to 920° C. at a heating rate of 5° C./min and subjected to heating reaction under the protection of flowing nitrogen for 2 h. The material was subjected to acid leaching in a 0.5 M H₂SO₄ solution for 24 h and placed in the porcelain combustion boat, the porcelain combustion boat was placed in the tube furnace, and the material was heated to 920° C. at a heating rate of 5° C./min and subjected to heating reaction under the protection of flowing nitrogen for 2 h to prepare a dodecahedral composite material Fe₃C—FeN/C-mix.

### Comparison Example 3

A difference between this example and Example 2 was that 5 mg of ferrocene was used to replace ferrocene monocarboxylic acid for hydrothermal reaction.

An LSV curve for ORR was obtained by the foregoing method, and E_{1/2}=0.85 V.

### Comparison Example 4

A preparation method of a ferrocene-doped MOF-derived metal carbide electrocatalyst included the following steps: 6.16 g of 2-methylimidazole was weighed and dissolved in 150 mL of methanol to prepare a solution A, 5.95 g of Zn(NO₃)₂·6H₂O was weighed and dissolved in 150 mL of methanol to prepare a solution B, the completely dissolved solution A was added to the solution B, and 5 mg of ferrocene monocarboxylic acid was added. The uniformly mixed solution was placed in a reactor at 100° C. for 12 h, a suspension obtained after hydrothermal reaction was centrifuged, washed, and oven-dried, the centrifugation was performed at 8,000 r/min for 3 min, and the oven-drying was performed at 50° C. for 12 h; and an oven-dried material was placed in a porcelain combustion boat, and the porcelain combustion boat was placed in a tube furnace. A test sample was heated to 920° C. at a heating rate of 5° C./min, kept at 920° C. for 2 h under the protection of flowing nitrogen, and naturally cooled to room temperature to prepare a metal carbide electrocatalyst.

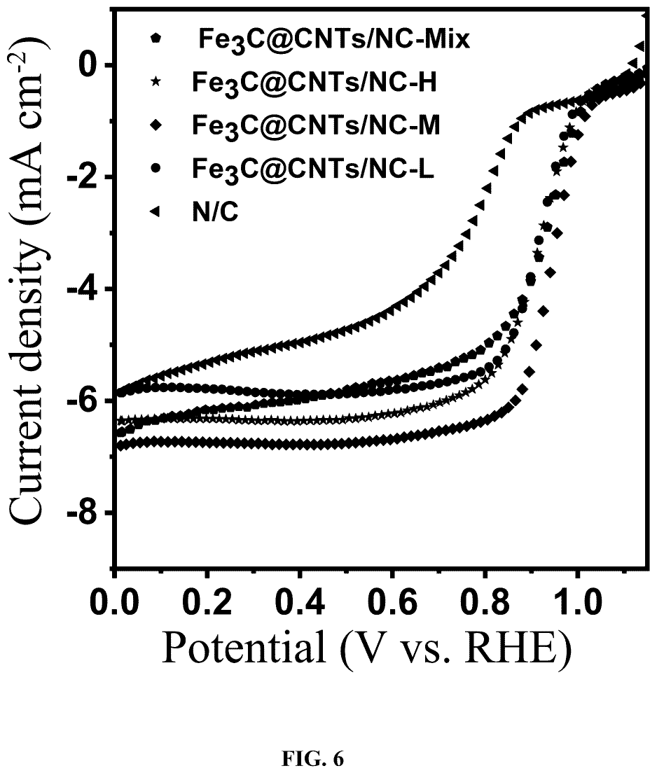

FIG. 6 shows LSV curves of the catalysts of Example 1 to Example 3, as well as the materials of Comparison Example 1 and Comparison Example 2 of the present disclosure. It can be known from FIG. 6 that the metal carbide electrocatalyst of the present disclosure has the best ORR properties. The half-wave potential of Fe3C—FeN/C—M is 0.941 V, which is greater than that (0.917 V) of Fe₃C—FeN/C—L, that (0.912 V) of Fe₃C—FeN/C—H, that (0.913 V) of Fe₃C—FeN/C-mix, and that (0.746 V) of N/C.

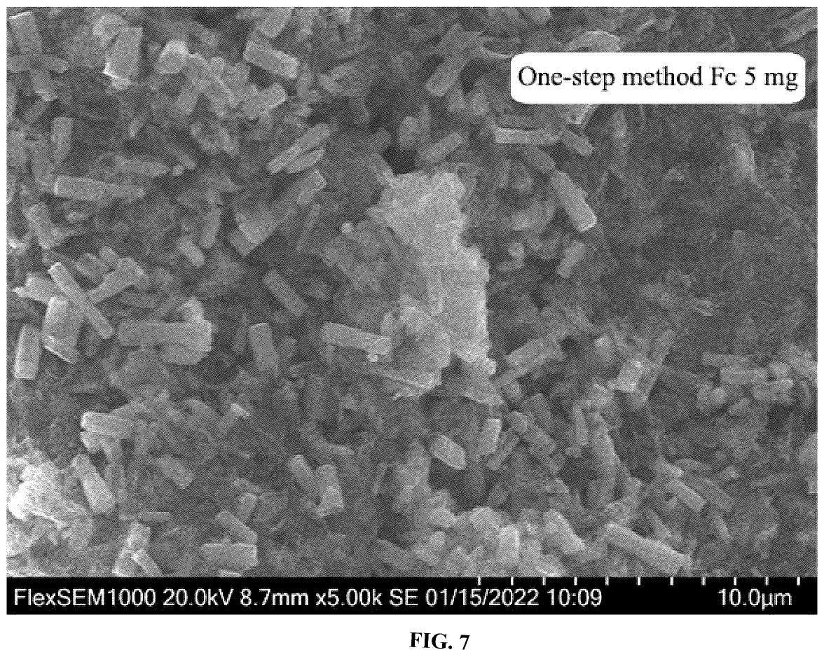

FIG. 7 shows an SEM image of the material of Comparison Example 4 of the present disclosure. It can be known from FIG. 7 that the purity of the ferrocene-doped material that is prepared by the one-step method of Comparison Example 4 is poor.

The foregoing embodiments are merely used for describing the technical solutions of the present disclosure, rather than limiting the present disclosure. Although the present disclosure has been described in detail with reference to the foregoing embodiments, those of ordinary skill in the art should understand that modifications may still be made to the technical solutions in the foregoing embodiments, or equivalent replacements may be made to some technical features, and these modifications or replacements do not cause the essence of the corresponding technical solutions to depart from the spirit and scope of the technical solutions of the embodiments of the present disclosure.

What is claimed is:

1. A preparation method of a ferrocene-doped MOF-derived metal carbide electrocatalyst, comprising the following steps:
S1: dissolving ZIF-8 in absolute methanol to prepare a solution A, and dissolving ferrocene monocarboxylic acid in DMF to prepare a solution B;
S2: uniformly mixing the solution A with the solution B to prepare a reaction solution, and performing a hydrothermal reaction on the reaction solution; and
S3: centrifuging, washing, oven-drying, and calcining and carbonizing a product obtained after the reaction in S2 to prepare the ferrocene-doped MOF-derived metal carbide electrocatalyst.

2. The preparation method of the ferrocene-doped MOF-derived metal carbide electrocatalyst according to claim 1, wherein in S1, a mass-to-volume ratio of ZIF-8 to absolute methanol is 20 mg: 2 mL.

3. The preparation method of the ferrocene-doped MOF-derived metal carbide electrocatalyst according to claim 1, wherein in S1, a mass-to-volume ratio of ferrocene monocarboxylic acid to DMF is (2-10) mg: 2 mL.

4. The preparation method of the ferrocene-doped MOF-derived metal carbide electrocatalyst according to claim 1, wherein in S2, in the reaction solution, a mass ratio of ZIF-8 to ferrocene monocarboxylic acid is 20: (2-10).

5. The preparation method of the ferrocene-doped MOF-derived metal carbide electrocatalyst according to claim 1, wherein in S2, the hydrothermal reaction is performed at 100° C. for 12-24 h.

6. The preparation method of the ferrocene-doped MOF-derived metal carbide electrocatalyst according to claim 1, wherein in S3, the centrifugation is performed at 6,000-10,000 r/min for 3-5 min, and the oven-drying is performed at 45-55° C. for 4-12 h.

7. The preparation method of the ferrocene-doped MOF-derived metal carbide electrocatalyst according to claim 1, wherein in S3, the calcination comprises: placing an oven-dried material in a porcelain combustion boat, placing the porcelain combustion boat in a tube furnace, and performing primary heating and calcination under the protection of inert gas; and performing acid leaching on the material in a 0.3-0.6 M H2SO4 solution for 20-30 h, placing the material in the porcelain combustion boat, placing the porcelain combustion boat in the tube furnace, and performing secondary heating and calcination under the same conditions as the primary heating and calcination.

8. The preparation method of the ferrocene-doped MOF-derived metal carbide electrocatalyst according to claim 7, wherein the primary heating and calcination and the secondary heating and calcination are performed at 900-950° C. and a heating rate of 3-5° C./min for 1.5-2.5 h.

9. A ferrocene-doped MOF-derived metal carbide electrocatalyst, prepared by the preparation method of the ferrocene-doped MOF-derived metal carbide electrocatalyst according to claim 1.

10. Application of the ferrocene-doped MOF-derived metal carbide electrocatalyst according to claim 9 serving as an oxygen reduction catalyst in a zinc-air battery.
